(19) United States
(12) Patent Application Publication
(10) Pub. No.: US 2017/0161122 A1
(43) Pub. Date: Jun. 8, 2017

(54) METHOD AND DEVICE FOR IMPLEMENTING A TRANSACTION CONCEPT IN OPC UA BY MEANS OF A TIMEOUT MECHANISM

(71) Applicant: SIEMENS AKTIENGESELLSCHAFT, 80333 München (DE)

(72) Inventors: KARL-HEINZ DEIRETSBACHER, Effeltrich (DE); MARKUS ERLMAN, Mainleus (DE); SVEN KERSCHBAUM, Fürth (DE); FRANK VOLKMANN, Nürnberg (DE)

(73) Assignee: SIEMENS AKTIENGESELLSCHAFT, 80333 München (DE)

(21) Appl. No.: 15/322,019

(22) PCT Filed: Jun. 25, 2014
(86) PCT No.: PCT/EP2014/063376

§ 371 Date: Dec. 23, 2016

(51) Int. Cl. G06F 9/54; H04L 12/18; H04L 29/08; H04L 29/06

(52) U.S. Cl. CPC G06F 9/542; H04L 67/42; H04L 12/1881; H04L 67/325; G06F 2209/541; G05B 2219/34263

(57) ABSTRACT

In the OPC UA request header, there exists the field “TimeoutHint”, by means of which the client can indicate the point in time from which the client is no longer interested in the result of an operation. When this time has expired, the server sends a response that the execution of the operation has been terminated. According to the invention, the semantics of the field “TimeoutHint” in the OPC UA request header are used differently. The meaning of the “TimeoutHint” is changed in such a way that the “TimeoutHint” no longer indicates the latest point in time at which an operation should be executed, but rather the earliest point in time.

OPC UA (OPC Unified Architecture) is an industrial standard protocol of the OPC Foundation for manufacturer-independent communication for the purpose of interchanging machine data, in particular in process automation.

OPC UA is a relatively new standard in which the original focus was not on controlling an industrial installation, but rather on the standardized interchange of information, in particular between devices from different manufacturers.

in the meantime, OPC UA has also been directly integrated in automation devices, thus resulting in the need to consistently write data.

In automation installations, there is a need to interchange process information (such as process values, measured values, parameters, control commands) between different devices. In this case, it is important that the information is transmitted consistently and in a failsafe manner between the subscribers. This is important, in particular, in the case of calls which change data (that is to say the writing of variables).

In practice, the consistency must be ensured over a plurality of individual calls in the installation. It may be the case that a change in the process intervenes in the process at a plurality of points, in which case the destinations of the calls are different and must be addressed by means of different calls.

Other reasons for the need for a plurality of different, but logically related calls would be, for example:

different security settings,

different type of call (write, method call),

organizational reasons.

In the case of OPC UA, variables are considered individually (even within a write call having a plurality of variables); the server communicates this to the client using individual status codes (for each variable). Other possibilities are not provided in the specification.

The information model specified by the OPC UA is no longer only a hierarchy of folders, items and properties. It is a so-called full-mesh network of nodes which is also used to represent meta information and diagnostic information in addition to the useful data relating to a node. A node resembles an object from object-oriented programming. A node may have attributes which can be read (data access DA, historical data access HDA). It is possible to define and call methods. A method has call arguments and return values. It is called by a command. Events which can be transmitted (AE, DA DataChange) in order to interchange particular information between devices are also supported. An event has, inter alia, a reception time, a message and a degree of severity. The above-mentioned nodes are used both for the useful data and for all other types of meta data. The OPC address space model thereby now also comprises a type model which is used to specify all data types.

Without contravening the OPC UA standard, a client and a server (which are tailored to one another) could agree that the server interprets a write call as ONE consistent write operation and accepts or rejects this call only as a whole.

A session concept (session) which is implemented using special service calls (BeginSession, ActivateSession, EndSession) is known in OPC UA. There may be a plurality of sessions which simultaneously exist on a server. However, only one such session is ever active at one time within an OPC UA connection. Sessions are used, inter alia, to uniquely assign a user or a role.

Without contravening the OPC UA standard, a client and a server (which are tailored to one another) could agree that the server interprets a write call as precisely one consistent write operation and accepts or rejects this call only as a whole.

However, this mechanism is not universal—as described above—but rather functions only

when the client and server are tailored to one another.

The client and server must interchange the information indicating that they are tailored to one another, that is to say this information must be transmitted in the log-on protocol, for example;

when there is precisely one changing call, and/or

when the destinations of the write operations are on the same destination system (aggregating servers could not be handled hereby).

As already stated further above, this does not suffice in practice since consistent operations often cannot be covered with a single changing call.

Therefore, the object of the invention is to specify a method and a device which rectify the problems described above.

The described object is achieved by means of a method and a device according to one of the independent patent claims.

A method for communicating between an OPC UA client and an OPC UA server of a client/server system using the OPC UA communication protocol is claimed, OPC UA calls being used for interaction between the client and the server.

In this case, the OPC UA calls are intended to be executed in a transaction-based manner, the OPC UA call containing an indication of an earliest time at which the OPC UA call is executed on the server, and the at least one OPC UA call being received and initially stored by the server.

The suitable devices for carrying out the method, namely a client and a server, are also claimed.

The OPC UA request header contains the field “TimeoutHint” which can be used by the client to indicate the time from which it is no longer interested in the result of an operation or to indicate the period after which the server should delete a (presumably “circling”) message.

If this time has expired, the server transmits a response stating that the execution of the operation has been aborted.

According to the invention, the semantics of the “TimeoutHint” field in the OPC UA request header is used differently than originally intended in the standard. In this case, the meaning of the “TimeoutHint” is changed in such a manner that it no longer indicates the latest time at which an operation is intended to be executed, but rather the earliest.

So that an operation is executed, a special item of information (trigger) must be transmitted from the client to the server within the time indicated in the “TimeoutHint”, which information triggers the execution of the operation.

This mechanism makes it possible to store a plurality of operations in the server which are then executed at the same time upon the arrival of the trigger. The information provided by the client in the “TimeoutHints” and time specifications (time stamps) must correlate in order to define an exact execution time.

If a suitable trigger does not arrive within the time indicated by the “TimeoutHint”, the stored operations are rejected.

A first advantageous embodiment operates in a “delayed response” mode.

In this case, the server retains the requests until the trigger arrives and provides the client with a response only when either the period indicated in the “TimeoutHint” has expired or when a suitable trigger is transmitted by the client.

As a result, the client receives a separate status code for each item changed by it. The response to the trigger, which passes from the server to the client, contains the overall result of the operation. The responses to the previously collected requests containing the detailed information are also sent to the client at the time of the trigger responses.

The operations are formally checked upon arrival on the server (the desired network nodes exist, for example). In the event of an error, the client immediately receives a response containing the information relating to the formal errors which have occurred.

The preview mode is presented as a second advantageous embodiment.

For each stored operation, the client receives a response from the server relating to the likely outcome of the operation immediately, that is to say not only after the trigger has arrived, irrespective of whether or not the operation will be successful. The client therefore receives a preview of what would happen if the operations were executed.

If the client determines that one of the operations carried out would not lead to the desired result, it can reject the operations by not transmitting a trigger. If the client wants the operations to be executed, it transmits the trigger. In the response to the trigger, the client receives the information relating to the overall result of all operations which have been executed.

In one advantageous embodiment, the actual detailed results of the operations which have been executed can be transmitted by the server via the event mechanism.

As a further advantageous embodiment, the client can abort the operation prematurely using an abort message. It therefore does not need to wait for the timeout.

The execution time can be advantageously stipulated either using a time which is communicated with the aid of the trigger operation or using the timeout time of the preceding operations.

As stated above, the problem of the consistent data-changing set operation is nowadays not addressed by OPC UA. This will increasingly be an important requirement in future, in particular during communication between automation systems.

The use of the timeout mechanism is a possible way of combining operations in one transaction in a manner which is simple to implement and manage. The complicated management of a transaction by means of transaction contexts etc. is dispensed with since the cohesion of the operations is synchronized using a time.

The lack of a possibility of a rollback, as is known from the transaction context (and is elementary thereto), initially appears to be disadvantageous. Upon closer consideration—in particular in the environment of automation solutions—it is determined that this functionality is not necessary and often also cannot be achieved. If a valve has been opened and a rollback is intended to be carried out for this, the physical event of opening the valve has already occurred and cannot be reversed without a reaction.

The OPC UA protocol does not need to be changed for communication between the server and the client according to the invention. However, the client and the server must have the same understanding of the use of the “TimeoutHint” field. The synchronization for this can be interchanged when setting up the connection, for example.

The invention is represented by figures and is explained in more detail below. In the drawing

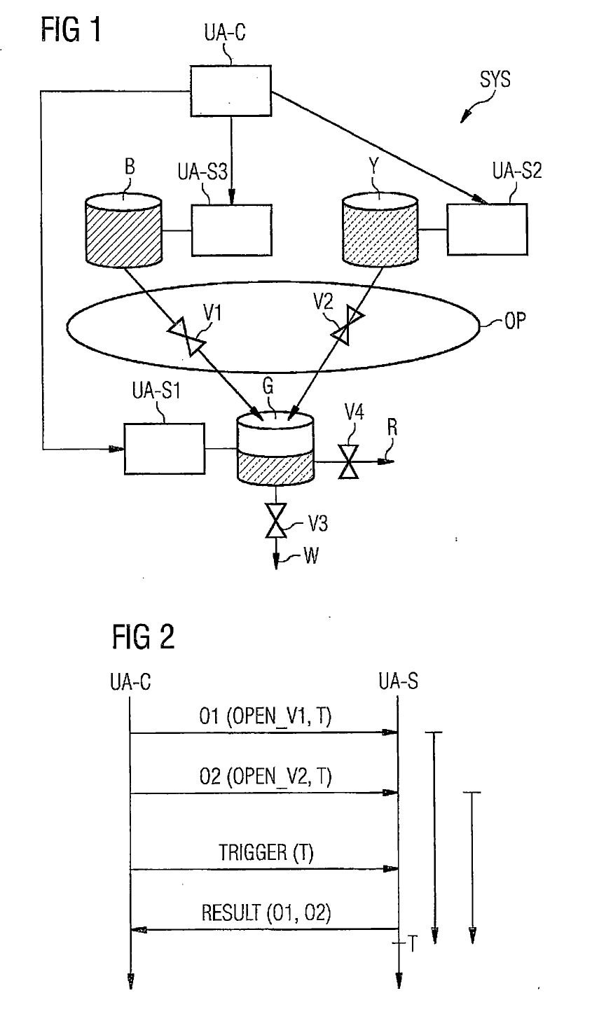

FIG. 1 shows an exemplary use of the invention in the automation environment,

FIG. 2 shows exemplary communication between the client and the server according to the first exemplary embodiment,

FIG. 3 shows exemplary communication between the client and the server according to the second exemplary embodiment, and

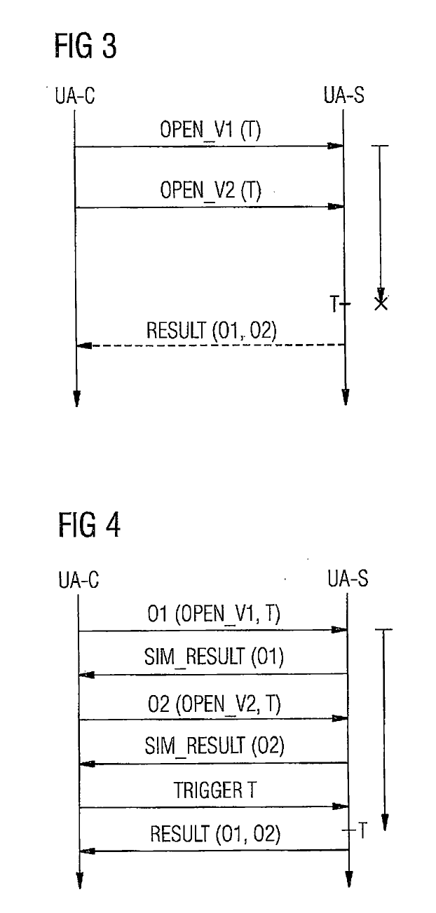

FIG. 4 shows further exemplary communication with simulated intermediate results.

The preferred exemplary embodiments are explained below. These examples are intended only to further clarify the invention, but are not intended to have a restrictive effect.

The exemplary task which is intended to be executed by the automation installation is that of mixing the color green from yellow and blue liquids, see FIG. 1. The installation contains three OPC UA servers: a server UA-S3 on the blue tank B, a server UA-S2 on the yellow tank Y and a server UA-S1 on the mixing tank G in which the green color is mixed. For the correct green mixture, the valves V1, V2 of the yellow and blue tanks must be opened at the same time. If the following error now occurs, whereby one of the valves V1, V2 cannot be correctly opened or closed (V3, V4), all open feed valves V1, V2 must first of all be closed again and the valve V4 on the mixing tank G must then be opened in the direction of disposal R in order to dispose of the collected liquid. The servers UA-S1, UA-S2 and US-S3 are controlled by the client UA-C.

Although a rollback would be desirable here, it is not possible. As a result of the valves being opened, liquid has already emerged from the two upper tanks B, Y and has flowed into the lower tank G. Only a defined state can be restored for the valves V1, V2. Additional work steps for restoring the original state, that is to say the disposal of the liquid which has entered the lower tank G for example, cannot be reproduced and must be tackled using programming.

FIGS. 2 to 4 now show exemplary communication operations between the client UA-C and the servers UA-S1, UA-S2, UA-S3 according to the invention.

FIG. 2 shows communication in which the execution of the operations is triggered by a trigger. A client UA-C transmits a first operation “open blue valve” O1(OPEN_V1, T) with a timeout time T to the server UA-S.

In one configuration of the invention, the server UA-S first of all formally checks the validity of the operation. In the event of an error, a corresponding message is transmitted to the client. Otherwise, the operation is stored in the server.

The client UA-C transmits a second operation “open yellow valve” O2(OPEN_V2, T) with the same timeout time T to the server UA-S.

In the above-mentioned configuration, the server again formally checks the validity of the operation O2 after receiving the second operation O2. In the event of an error, a corresponding message is transmitted to the client. Otherwise, the operation is likewise stored in the server.

If the client UA-C now wishes to execute the two operations, it transmits the trigger message TRIGGER(T) to the server UA-S. The server executes the operations and transmits a response RESULT(O1, O2) back to the client for confirmation.

FIG. 3 initially shows the same procedure: UA-C transmits a first operation “open blue valve” O1(OPEN_V1, T) with a timeout time T to the server UA-S. The client UA-C then transmits a second operation “open yellow valve” O2(OPEN_V2, T) with the same timeout time T to the server UA-S.

If a trigger message is not transmitted by the client within the period T, the operations stored in the servers are rejected after expiry of the period indicated in the “TimeoutHint” field of the operation command and an error message RESULT(O1, O2) is possibly transmitted back to the client UA-C.

FIG. 4 shows yet another exemplary embodiment. After receiving the first operation O1(OPEN_V1, T), the server UA-S possibly formally checks the validity of the operation and then simulates the requested operation. As a response to the operation, the client UA-C receives the result of this simulation as a preview SIM_RESULT(O1). The actual result of the operation can no longer be delivered to the client later since it has already received the response to the request.

After receiving the second operation O2(OPEN_V2, T), the server UA-S formally checks the validity of the operation and “simulates” the operation O2. As a response to the operation, the client UA-C receives the result of this simulation as a preview SIM_RESULT(O2). The actual result of the operation can longer be delivered to the client UA-C later since it has already received the response to the. request.

If the client UA-C is not satisfied with one of the delivered preview results, it can abort the entire operation by allowing the timeout time to elapse.

The execution time can be stipulated by the client UA-C either by the timeout time or by a time T delivered with the trigger.

What is claimed is:

1.-10. (canceled)

11. A method of communication between a client and a server in a client/server system using the OPC UA communication protocol, said method comprising:
the server receiving at least one OPC UA call from the client after opening a communication session with the client, said call containing an indication of an earliest time at which to execute the OPC UA call on the server; and
the server storing the at least one OPC UA call.

12. The method of claim 11, wherein a “TimeoutHint” field defined in the OPC UA standard as indicating a latest execution time is changed so that it indicates the earliest execution time

13. The method of claim 11, further comprising:
the server initially simulating the execution of the at least one OPC UA call; and
the server transmitting the result of the simulation to the client.

14. The method of claim 11, further comprising:
the server receiving and time stamping a message adapted to trigger said at least one OPC UA call; and
the server initiating execution of said OPC UA call only if the time stamp on said trigger message correlates with the time of said execution.

15. The method of claim 11, wherein the at least one OPC UA call indicates an execution time, further comprising the server initiating execution of at least one OPC UA call when the execution time indicated in the OPC UA call has been reached.

16. The method of claim 11, further comprising:
the at least one OPC UA call received by the server is first formally checked; and
the server transmits an error message to the client when the check reveals an error.

17. The method of claim 11, wherein the server has opened a session, further comprising the server transmitting a result call to the client after executing the at least one OPC UA call, said result call containing the collected results of all calls executed in said session.

18. The method of claim 11, further comprising transmitting an abort message to prevent the execution of at least said at least one OPC UA call by the server.

19. A client device adapted for communicating with a server in a client/server system using the OPC UA communication protocol for communication between a client and a server, at least one OPC UA call transmitted by the client device to the server being executed on the server in a transaction-based manner, said client device comprising:
a client, said client being adapted for transmitting and receiving calls in a client/server system using the OPC UA communication protocol; and
a transaction processor, said transaction processor being adapted for receiving at least a first OPC UA service call transmitted by the client to the server, said transaction processor forwarding said first OPC UA service call to the server with an indication of an earliest time at which to execute the OPC UA call on the server, said transaction processor transmitting said at least one OPC UA call to the server and storing it on the server.

20. The client device of claim 19, wherein the transaction processor changes a “TimeoutHint” field defined in the OPC UA standard as indicating a latest execution time so that it indicates the earliest execution time

21. The client device of claim 19, wherein the client transmits a message adapted to trigger said at least one OPC UA call and the server initiates execution of said OPC UA call only when the time stamp provided on said trigger message by the server when that trigger message was received by the server correlates with said earliest time of execution of said call.

22. The client device of claim 19, wherein the at least one OPC UA call received by the server from the client is formally checked and the client receives an error message from the server when the check reveals an error.

23. The client device of claim 19, wherein the client receives a result call from the server after the at least one OPC UA call is executed, said server having opened a session with the client before the at least one OPC UA call was executed, said result call containing the collected results of all calls executed in said session.

24. The client device of claim 19, wherein an abort message is produced and transmitted by the client that prevents the execution of said at least one OPC UA call by the server.

25. A server device adapted for communicating with a client in a client/server system using the OPC UA communication protocol for communication between the client and the server, at least one OPC UA call transmitted by the client to the server device being executed on the server in a transaction-based manner, said server device comprising:
a server, said server being adapted for transmitting, executing and receiving calls in a client/server system using the OPC UA communication protocol; and
a transaction processor, said transaction processor being adapted to indicate an earliest time at which to execute the at least one OPC UA call on the server, said transaction processor storing said at least one OPC UA call and earliest time on the server.

26. The server device of claim 25, wherein a “TimeoutHint” field defined in the OPC UA standard as indicating a latest execution time is changed so that it indicates the earliest execution time to the transaction processor.

27. The server device of claim 25, wherein the server initially simulates the execution of the at least one OPC UA call; and transmits the result of the simulation to the client.

28. The server device of claim 25, wherein the transaction processor time stamps a message adapted to trigger said at least one OPC UA call that is received by the server and the transaction processor initiates execution of said OPC UA call by the server only when the time stamp on said trigger message correlates with said earliest time of execution of said call.

29. The server device of claim 25, wherein the at least one OPC UA call indicates an execution time, and the transaction processor initiates execution of said at least one OPC UA call by server when the execution time indicated in said OPC UA call has been reached.

30. The server device of claim 25, wherein the at least one OPC UA call received by the server is first formally checked by the transaction processor and the server transmits an error message to the client when the check by the transaction processor reveals an error.

31. The server device of claim 25, wherein the server transmits a result call to the client after executing the at least one OPC UA call, said server having opened a session with the client before the at least one OPC UA call was executed, said result call containing the collected results of all calls executed in said session.

32. The server device of claim 25, wherein an abort message received by the server from the client prevents the execution of the at least one OPC UA call by the server.

33. A transaction processor, said transaction processor being adapted for providing execution of at least a first OPC UA service call transmitted between a server and a client in a client/server system using the OPC UA communication protocol in a transaction-based manner, when connected between the server and the client, said processor comprising:
a communication routine adapted to receive and transmit OPC UA calls between a server and a client in the client/server system; and
a transaction specification routine adapted to indicate an earliest time at which to execute the at least one OPC UA call on the server and to store said at least one OPC UA call and said earliest time on the server.

34. A transaction specification program fixed in a machine-readable medium, said program providing execution of at least a first OPC UA service call transmitted between a server and a client in a client/server system using the OPC UA communication protocol in a transaction-based manner, said program comprising:
a communication routine adapted to receive and transmit OPC UA calls between a server and a client in the client/server system; and
a transaction specification routine adapted to indicate an earliest time at which to execute the at least one OPC UA call on the server and to store said at least one OPC UA call and said earliest time on the server.
